(19) United States
(12) Patent Application Publication
(10) Pub. No.: US 2017/0320285 A1
(43) Pub. Date: Nov. 9, 2017

(54) COMMUNICATION CABLES AND COMPONENTS THEREOF

(71) Applicant: Panduit Corp., Tinley Park, IL (US)

(72) Inventors: Royal O. Jenner, Tinley Park, IL (US); Masud Bolouri-Saransar, Orland Park, IL (US); Ronald A. Nordin, Naperville, IL (US); Paul W. Wachtel, Arlington Heights, IL (US); Stephen Thwaites, Walton, KY (US); Roy Kusuma, Cincinnati, OH (US); James Malkemus, Union, KY (US); Scott Brown, Independence, KY (US); Gary E. Frigo, New Lenox, IL (US)

(73) Assignees: Panduit Corp., Tinley Park, IL (US); General Cable Technologies Corporation, Highland Heights, KY (US)

(21) Appl. No.: 15/590,227

(22) Filed: May 9, 2017

Related U.S. Application Data
(60) Provisional application No. 62/333,360, filed on May 9, 2016.

(51) Int. Cl. B32B 3/16; B32B 15/20; B32B 15/082; B32B 38/10; B32B 7/12

(52) U.S. Cl. CPC B32B 3/16; B32B 38/10; B32B 7/12; B32B 15/082; B32B 15/20

(57) ABSTRACT

In one embodiment a matrix tape includes a support layer, a metallic layer composed of metallic segments attached to the support layer and a barrier layer attached to the support layer opposite the metallic layer. In another embodiment a matrix tape includes a support layer, a metallic layer composed of metallic segments attached to the support layer and a strength member attached to the metallic layer opposite the support layer. In a third embodiment a method of manufacturing a matrix tape includes providing a payout and an uptake reel. Dispensing a tape with a support layer and a metallic layer from the payout reel, ablating the metallic reel with a laser, attached at least one of a strength member or a barrier layer to the tape, and spooling the tape on the uptake reel.

### CROSS REFERENCE TO RELATED APPLICATIONS

This application claims priority to U.S. Provisional Application No. 62/333,360, filed May 9, 2016, the subject matter of which is hereby incorporated by reference in its entirety.

### FIELD OF INVENTION

Embodiments of the present invention generally relate to the field of network communication, and more specifically, to twisted pair communication cables with foil tape and methods of manufacture thereof.

### BACKGROUND

Communication networks often rely on twisted pair communication cables (such as Cat 6A cables) to transmit electronic signals between equipment. Due to inherent electromagnetic phenomenon associated with differential signal transmission, alien crosstalk between neighboring cable can be a significant issue. This can be especially problematic in high-density environments such as data centers and telecom rooms of various enterprises.

U.S. Pat. No. 8,558,115 to Jenner et al. which is incorporated herein by reference in its entirety, describes the use of a foil tape as part of a communication cable in an attempt to address the problem of alien crosstalk. As described in the background thereof, in an embodiment the '115 patent teaches a laser ablation system that is used to selectively remove regions or paths in a metallic layer of a foil tape to produce random distributions of randomized shapes, or pseudo-random patterns or long pattern lengths of discontinuous shapes in the metal layer. While such tape has demonstrated itself to be effective in achieving the desired electromagnetic performance, the process of laser ablation does feature a number of drawbacks.

For example, during the ablation process heat is generated by the lasers to vaporize the metallic layer. This heat can cause the underlying substrate (typically a layer of polymer film) to weaken. In addition, during the cable manufacture process tensions and temperatures are created that may exacerbate weaknesses in the substrate, causing damage or breakage in the foil tape.

Another drawback of the system outlined in the '115 patent is that due to the removal of metallic material via ablation, channels between various shapes are created. If, during jacketing, the temperatures are relatively high, hot PVC jacket polymer in a semi-molten state may flow into the ablated regions of the aluminum causing witness lines on the outer jacket of the cable.

In view of the above, there is a continued need for improved foil tape/communication cable designs and improved methods of manufacture thereof.

### DESCRIPTION

Accordingly, at least some embodiments of the present inventing are directed to improved foil tape/communication cable designs and improved methods of manufacture thereof.

As used herein, the terms “foil tape” and “matrix tape” may be used interchangeably and shall refer to the same thing.

Shown in FIG. 1 is a cross section of a cable according to an embodiment of the present invention. As illustrated therein, the cable includes a cable core that is comprised of a plurality of twisted pairs of conductors (in this case four pairs) and a pair divider. The core is at least partially surrounded by a barrier tape which in turn is at least partially surrounded by a matrix tape. A final jacket layer is disposed on the cable to cover the internal components.

FIG. 2 illustrates a partial cross section of an embodiment of a matrix tape in accordance with the present invention. As shown therein, the matrix tape includes a metallic layer (e.g., aluminum layer) that is supported by a support layer. Optionally, an adhesive may be present between the metallic layer and the support layer. The matrix tape further includes a barrier layer that is attached to the support layer via an optional second adhesive layer. As shown in FIG. 2, the barrier layer is attached to a side of the support layer that is opposite of the side that is attached to the metallic layer.

The addition of a support layer may provide improved resiliency to the matrix tape by preventing or reducing damage to the underlying barrier layer. Furthermore, having a multi-layer matrix tape construction profile allows for greater freedom to select an appropriate material for the barrier layer. FIG. 3 illustrates examples of various materials that may be used in the construction of the barrier layer. The advantage of the stack shown in FIG. 2 is that not every barrier layer material may be conducive to acting as a support layer for the metallic layer that is being ablated. For example, a foam barrier may not be ideal for supporting a material that is being laser ablated. At the same time, that same material might, in fact, prove superior for acting as the barrier layer, providing improved electromagnetic shielding and/or acting as a strength member. As a result, the matrix tape of FIG. 2 may incorporate advantages of multiple materials in a single tape that can further simplify the cable assembly process.

FIG. 4 illustrates another embodiment of the present invention. Shown therein is a partial cross section of a matrix tape that includes a support layer that supports a metallic layer (e.g., an aluminum layer that is laser ablated at some point in time) with a strength member deposited on top of said metallic layer. Optional adhesive layers may be disposed between the support and metallic layers, and between metallic and strength layers. The strength member (a.k.a. layer) is applied after the metallic layer is ablated. This provides a barrier between the PVC jacket polymer in a semi-molten state and the grooves that form as a result of the ablation process. Furthermore, the strength member may act as a layer that provides additional strength and reinforces the matrix tape. Note that the strength member can be implemented in any embodiment described herein.

The matrix tape described herein can be manufactured pursuant to an exemplary process represented in FIG. 5. Shown therein is a block representation of a manufacturing line for the matrix tape which includes a payout reel (A), a plurality of lasers, a payout reel D, a payout reel E, and an uptake reel B. In the process shown here, payout reel A dispenses the A1/polymer tape that includes a support layer and a metallic layer on top thereof. This tape passes through a section of the manufacturing line where one or more lasers ablate the metallic layer to create metallic sections out of the metallic layer. Note that these metallic sections can be any form, and can, but do not have to, be electrically isolated from neighboring metallic sections. Once the metallic layer has been ablated, the tape passes through downstream sections where at least one of the barrier layer (dispensed from payout reel (D)) and the strength member layer (dispensed from payout reel (E)) is/are applied to the tape. Upon the application of one of both of these layers, the tape is spooled up into the uptake reel (B) as a final step. Thereafter, the matrix tape can be installed in a network cable either helically or as a cigarette wrap.

The advantage of the process represented in FIG. 5 is that the application of the barrier and/or the strength member layers occurs immediately after laser ablation and before the tape is spooled up on an uptake reel. This may increase the integrity of the tape as the tape undergoes less external forces between the time that it is ablated and the time when it is strengthened via the barrier and/or strength member layers. In other words, if the matrix tape was spooled up after laser ablation and then unspooled for application of the barrier and/or strength member layers, the spooling and unspooling processes can degrade the tape's integrity leading to potential structural deficiencies and/or reduced electromagnetic performance.

Note that while this invention has been described in terms of several embodiments, these embodiments are non-limiting (regardless of whether they have been labeled as exemplary or not), and there are alterations, permutations, and equivalents, which fall within the scope of this invention. Additionally, the described embodiments should not be interpreted as mutually exclusive, and should instead be understood as potentially combinable if such combinations are permissive. It should also be noted that there are many alternative ways of implementing the methods and apparatuses of the present invention. It is therefore intended that claims that may follow be interpreted as including all such alterations, permutations, and equivalents as fall within the true spirit and scope of the present invention.

### SUMMARY

In one embodiment a matrix tape includes a support layer, a metallic layer composed of metallic segments attached to the support layer and a barrier layer attached to the support layer opposite the metallic layer. In another embodiment a matrix tape includes a support layer, a metallic layer composed of metallic segments attached to the support layer and a strength member attached to the metallic layer opposite the support layer. In a third embodiment a method of manufacturing a matrix tape includes providing a payout and an uptake reel. Dispensing a tape with a support layer and a metallic layer from the payout reel, ablating the metallic reel with a laser, attached at least one of a strength member or a barrier layer to the tape, and spooling the tape on the uptake reel.

### BRIEF DESCRIPTION OF THE FIGURES

FIG. 1 is a cross section of a cable with a matrix tape according to the present invention.

FIG. 2 is a partial cross section of a first embodiment of a matrix tape.

FIG. 3 illustrates various embodiments of the barrier layer of the matrix tape of FIG. 2.

FIG. 4 is a partial cross section of a second embodiment of a matrix tape.

FIG. 5 is a block diagram showing a method for making the matrix tape of FIGS. 2 and 4.

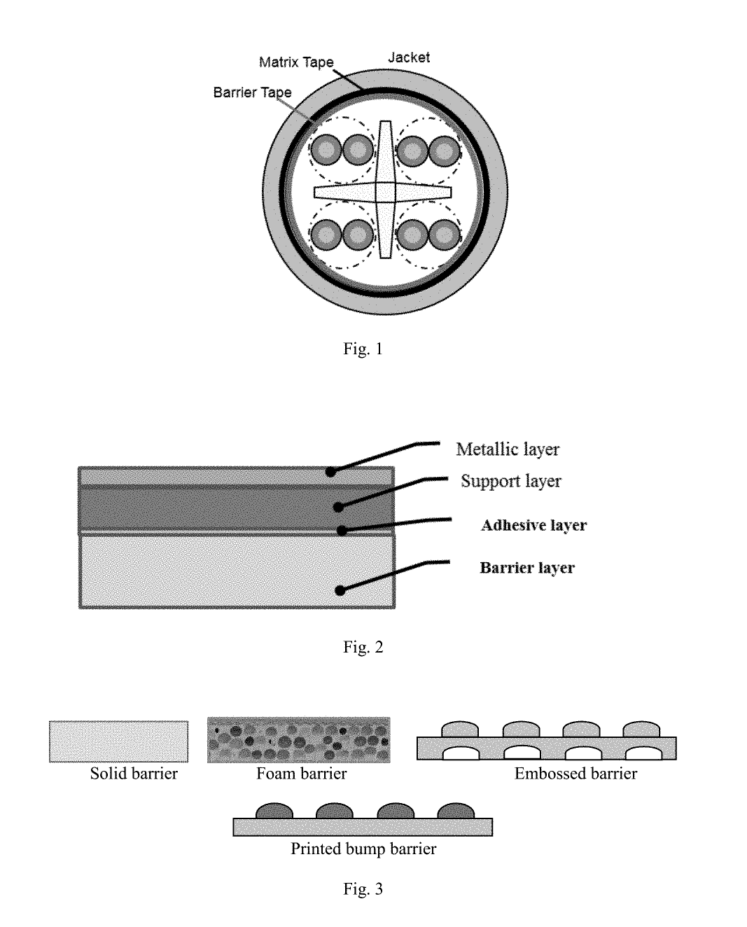

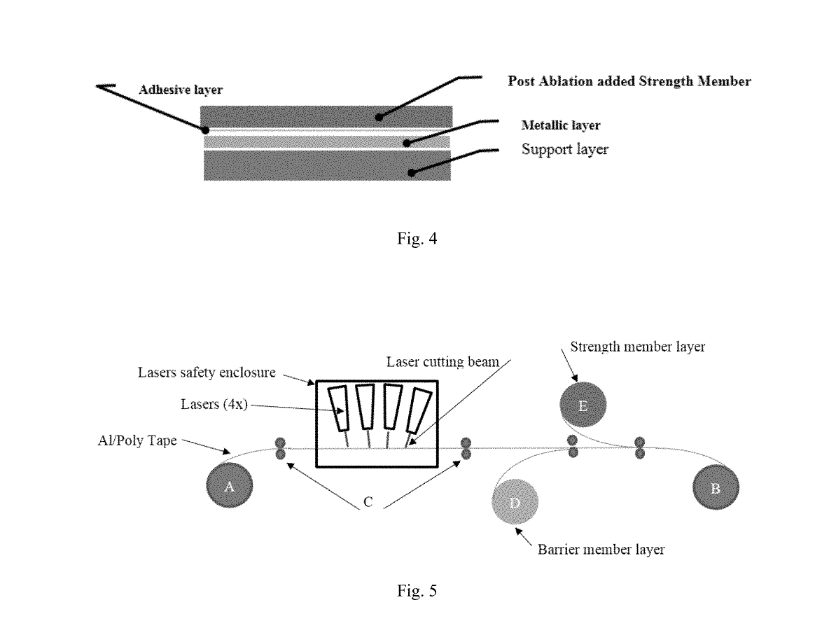

We claim:

1. A matrix tape for use with a communications cable comprising:
a support layer;
a metallic layer composed of metallic segments attached to the support layer; and
a strength member attached to the metallic layer opposite the support layer.

2. The matrix tape of claim 1 further comprising an adhesive layer between the support layer and the metallic layer.

3. The matrix tape of claim 2 further comprising an adhesive layer between the strength member layer and the metallic layer.

4. A matrix tape for use with a communications cable comprising:
a support layer;
a metallic layer composed of metallic segments attached to the support layer; and
a barrier layer attached to the support layer opposite the metallic layer.

5. The matrix tape of claim 4 further comprising an adhesive layer between the metallic layer and the support layer.

6. The matrix tape of claim 5 further comprising and adhesive layer between the barrier layer and the support layer.

7. A method of making a matrix tape for use with a communications cable comprising:
providing a payout reel and an uptake reel;
dispensing a tape from the payout reel which has a support layer attached to a metallic layer;
ablating the metallic layer of the tape such as to create metallic sections on the tape;
applying at least one of a strength member and a barrier layer to the tape; and
spooling the tape on the uptake reel.
